(19) United States
(12) Patent Application Publication
(10) Pub. No.: US 2022/0044170 A1
(43) Pub. Date: Feb. 10, 2022

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Daiki KANEICHI, Tokyo-to (JP); Takuma FUTOHASHI, Tokyo-to (JP); Kento NITTA, Tokyo-to (JP)

(73) Assignee: TOYOTA JIDOSHA KABUSHIKI KAISHA, Toyota-shi (JP)

(21) Appl. No.: 17/387,492

(22) Filed: Jul. 28, 2021

(30) Foreign Application Priority Data
Aug. 7, 2020 (JP) 2020-134756

(51) Int. Cl. G06Q 10/06

(52) U.S. Cl. CPC G06Q 10/06311

(57) ABSTRACT

An object is to manage work by a plurality of crew members who perform predetermined work on board a vehicle among a plurality of vehicles. An information processing apparatus manages the work by the plurality of crew members who perform the predetermined work on board a vehicle among a plurality of vehicles. The information processing apparatus determines a crew order that is an order of priority for each of the plurality of crew members to board a vehicle among the plurality of vehicles, the crew order being determined in order of a longest elapsed time since each of the plurality of crew members previously exited a vehicle among the plurality of vehicles. Additionally, the information processing apparatus transmits schedule information including the crew order to a plurality of first terminals respectively associated with the plurality of crew members.

### CROSS REFERENCE TO THE RELATED APPLICATION

This application claims the benefit of Japanese Patent Application No. 2020-134756, filed on Aug. 7, 2020, which is hereby incorporated by reference herein in its entirety.

### BACKGROUND

### Technical Field

The present disclosure relates to an information processing apparatus, an information processing method, and a non-transitory storage medium.

### Description of the Related Art

Japanese Patent Laid-Open No. 2016-060431 discloses a crew operations management apparatus that manages the operations of crew members who perform duties on a train for transportation. The crew operations management apparatus disclosed in Japanese Patent Laid-Open No. 2016-060431 includes: a route information editing unit that creates route information including information about a train on which a crew member performs duties corresponding to a service schedule; a route information modification history editing unit that creates route information modification information indicating a difference in routes before and after a change when the route information is changed in correspondence with a change in the service schedule; and a route information transmission management unit that transmits the route information and the route information modification information to a portable crew terminal carried by the crew member when the route information is modified.

### SUMMARY

An object of the present disclosure is to manage work by a plurality of crew members who perform predetermined work on board a vehicle among a plurality of vehicles.

An information processing apparatus according to a first aspect of the present disclosure is

an information processing apparatus that manages work by a plurality of crew members who perform predetermined work on board a vehicle among a plurality of vehicles, the information processing apparatus comprising a controller comprising at least one processor configured to:

determine a crew order that is an order of priority for each of the plurality of crew members to board a vehicle among the plurality of vehicles, the crew order being determined in order of a longest elapsed time since each of the plurality of crew members previously exited a vehicle among the plurality of vehicles; and

transmit schedule information including the crew order to a plurality of first terminals respectively associated with the plurality of crew members.

An information processing method according to a second aspect of the present disclosure is

an information processing method executed by a computer that manages work by a plurality of crew members who perform predetermined work on board a vehicle among a plurality of vehicles, the information processing method comprising:

determining a crew order that is an order of priority for each of the plurality of crew members to board a vehicle among the plurality of vehicles, the crew order being determined in order of a longest elapsed time since each of the plurality of crew members previously exited a vehicle among the plurality of vehicles; and

transmitting schedule information including the crew order to a plurality of first terminals respectively associated with the plurality of crew members.

A non-transitory storage medium according to a third aspect of the present disclosure is

a non-transitory storage medium storing a program executed by a computer that controls a terminal associated with each of a plurality of crew members who perform predetermined work on board a vehicle among a plurality of vehicles, the program causing the terminal to:

receive, from an information processing apparatus that manages the work by the plurality of crew members, schedule information including a crew order that is an order of priority for each of the plurality of crew members to board a vehicle among the plurality of vehicles and a vehicle order related to the plurality of vehicles that is an order of priority for being boarded by a crew member among the plurality of crew members; and

display the crew order for the plurality of crew members and a vehicle that is in first place of the vehicle order among the plurality of vehicles on a display.

According to the present disclosure, it is possible to manage work by a plurality of crew members who perform predetermined work on board a vehicle among a plurality of vehicles.

### BRIEF DESCRIPTION OF THE DRAWINGS

FIG. 1 is a diagram illustrating a schematic configuration of a work management system;

FIG. 2 is a block diagram schematically illustrating an example of a functional configuration of a crew terminal associated with a standby crew member, a crew terminal associated with a specific crew member, and a management server in a first embodiment;

FIG. 3 is a diagram illustrating an example of a table structure of crew information;

FIG. 4 is a diagram illustrating an example of a table structure of schedule information;

FIG. 5 is a diagram illustrating an example of a boarding screen in the first embodiment;

FIG. 6 is a sequence diagram illustrating a first flow of information and processing in a work management system;

FIG. 7 is a sequence diagram illustrating a second flow of information and processing in the work management system;

FIG. 8 is a block diagram schematically illustrating an example of a functional configuration of a crew terminal associated with a standby crew member, a crew terminal associated with a specific crew member, and a management server in a second embodiment;

FIG. 9 is a diagram illustrating an example of a table structure of work information;

FIG. 10 is a diagram illustrating an example of a boarding screen in the second embodiment; and

FIG. 11 is a flowchart of a replacement instruction process.

### DESCRIPTION OF THE EMBODIMENTS

An information processing apparatus according to a first aspect of the present disclosure is an information processing apparatus that manages work by a plurality of crew members who perform predetermined work on board a vehicle among a plurality of vehicles. A controller comprising at least one processor in the information processing apparatus according to the first aspect of the present disclosure determines a crew order for the plurality of crew members. The crew order is an order of priority for when each of the plurality of crew members boards one of the plurality of vehicles. The controller determines the crew order in order of the longest elapsed time since each of the plurality of crew members previously exited a vehicle among the plurality of vehicles. Additionally, the controller in the information processing apparatus transmits schedule information including the crew order to a plurality of crew terminals. Here, each crew terminal is a terminal associated with each crew member.

In this way, the information processing apparatus determines the crew order. Additionally, the information processing apparatus transmits schedule information to the plurality of crew terminals. As a result, according to the crew order included in the schedule information, the plurality of crew members are encouraged to board one of the plurality of vehicles and start the predetermined work in order of the crew member with the longest elapsed time since previously exiting one of the plurality of vehicles. With this arrangement, the work by the plurality of crew members can be managed by the information processing apparatus.

Hereinafter, a specific embodiment of the present disclosure will be described on the basis of the drawings. Properties such as the dimensions, materials, shapes, and relative arrangement of the components described in the present embodiment are not intended to limit the technical scope of the present disclosure thereto unless specifically indicated otherwise.

### First Embodiment

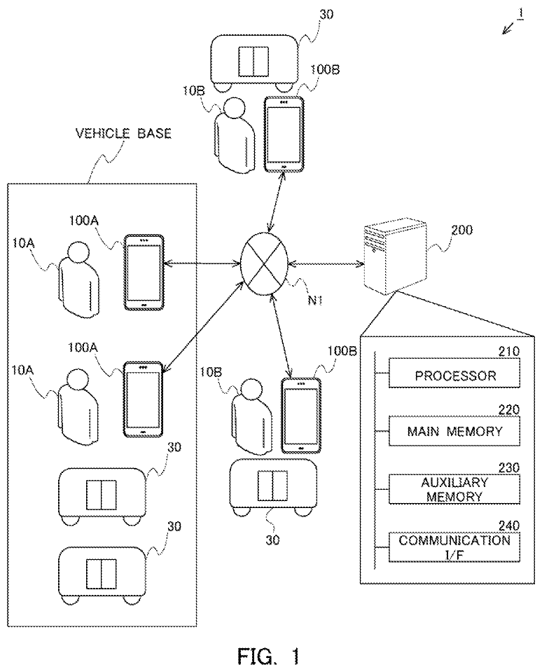

A work management system 1 according to the present embodiment will be described on the basis of FIG. 1. FIG. 1 is a diagram illustrating a schematic configuration of the work management system 1. The work management system 1 includes a plurality of crew terminals 100 (100A, 100B) and a management server 200.

A plurality of crew members 10 board vehicles 30 and perform predetermined work outside a vehicle base. The plurality of crew members 10 stand by inside the vehicle base. Here, the vehicles 30 are vehicles capable of autonomous travel. The vehicles 30 depart from the vehicle base and travel outside the vehicle base. A crew member 10 standing by inside the vehicle base (hereinafter referred to as the “standby crew member 10A” in some cases) boards a vehicle 30 among the plurality of vehicles 30. A crew member 10 on board a vehicle 30 among the plurality of vehicles 30 (hereinafter referred to as the “specific crew member 10B” in some cases) performs predetermined work on board the vehicle 30. The predetermined work is, for example, guiding a travel route to passengers on board the vehicle 30. As another example, the predetermined work is driving the vehicle 30 instead of the autonomous travel function of the vehicle 30 outside the vehicle base.

Each crew terminal 100A is a terminal associated with each standby crew member 10A. Here, each crew terminal 100A is a device such as a personal computer, a smartphone, a wearable terminal, or a tablet computer carried by each standby crew member 10A. Each crew terminal 100B is a terminal associated with each specific crew member 10B. Here, each crew terminal 100B is a device such as a personal computer, a smartphone, a wearable terminal, or a tablet computer carried by each specific crew member 10B. Note that the crew terminal 100A in the present embodiment corresponds to a “first terminal” according to the present disclosure. Also, the crew terminal 100B in the present embodiment corresponds to a “second terminal” according to the present disclosure. Additionally, in the present embodiment, the crew members 10 carry the same crew terminal 100 while standing by inside the vehicle base and also while on board the vehicles 30. In other words, the crew terminal 100A and the crew terminal 100B are a single terminal.

The management server 200 is a server apparatus that manages the work by the plurality of crew members 10. The management server 200 includes a computer provided with a processor 210, main memory 220, auxiliary memory 230, and a communication interface (communication I/F) 240. The processor 210 is a central processing unit (CPU) or a digital signal processor (DSP), for example. The main memory 220 is random access memory (RAM), for example. The auxiliary memory 230 is read-only memory (ROM), for example. Alternatively, the auxiliary memory 230 is a hard disk drive (HDD) or a disc-based recording medium such as a CD-ROM, a DVD, or a Blu-ray Disc, for example. The auxiliary memory 230 may also be a removable medium (removable storage medium). Examples of removable media include USB memory or an SD card. The communication I/F 240 is a local area network (LAN) interface board or a wireless communication circuit for wireless communication, for example.

In the management server 200, an operation system (OS), various programs, various information tables, and the like are stored in the auxiliary memory 230. Also, in the management server 200, the processor 210 is capable of achieving various functions like the functions described later by loading a program stored in the auxiliary memory 230 into the main memory 220 and executing the program. However, some or all of the functions in the management server 200 may also be achieved by a hardware circuit such as an ASIC or an FPGA. Note that the management server 200 is not necessarily realized by a single physical configuration, and may also be configured by a plurality of computers that cooperate with each other. Note that the management server 200 according to the present embodiment corresponds to an “information processing apparatus” according to the present disclosure.

In the work management system 1, each crew terminal 100A, each crew terminal 100B, and the management server 200 are interconnected by a network N1. A wide area network (WAN), that is, a global public communication network such as the Internet, or a telephone communication network such as a mobile phone network may be adopted as the network N1, for example.

(Functional Configuration)

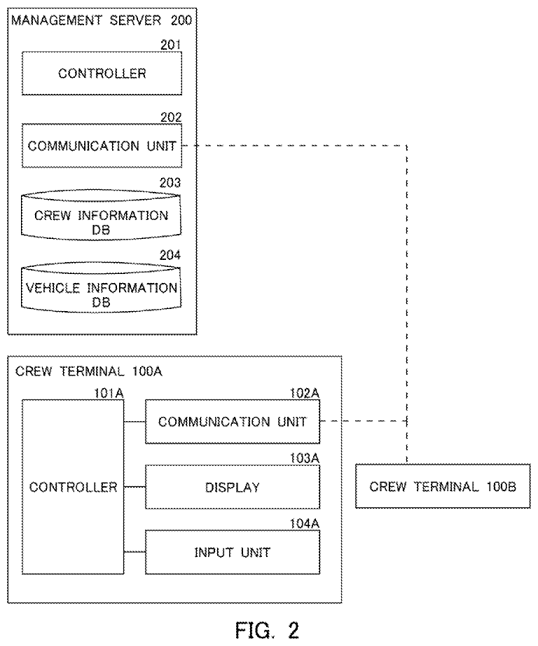

Next, a functional configuration of each of the crew terminal 100A, the crew terminal 100B, and the management server 200 forming the work management system 1 according to the present embodiment will be described on the basis of FIGS. 2 to 5. FIG. 2 is a block diagram schematically illustrating an example of a functional configuration of the crew terminal 100A, the crew terminal 100B, and the management server 200 in the present embodiment.

(Management Server)

The management server 200 includes a controller 201, a communication unit 202, a crew information database (crew information DB) 203, and a vehicle information database (vehicle information DB) 204. The controller 201 has a function of performing computational processing for controlling the management server 200. The controller 201 can be achieved by the processor 210 in the management server 200. The communication unit 202 has a function of connecting the management server 200 to the network N1. The communication unit 202 can be achieved by the communication I/F 240 in the management server 200.

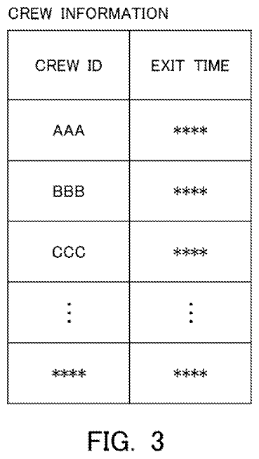

The crew information DB 203 is a database storing crew information related to the standby crew members 10A. The crew information DB 203 can be achieved by the auxiliary memory 230 in the management server 200. FIG. 3 is a diagram illustrating an example of a table structure of crew information. As illustrated in FIG. 3, the crew information includes a crew ID field and an exit time field. A crew ID, which is an identifier for specifying a crew member 10 (standby crew member 10A), is input into the crew ID field. The crew ID is the name of a crew member 10, for example. An exit time, which is the time when each standby crew member 10A previously exited a vehicle 30, is input into the exit time field. The exit time is input on the basis of the time when the crew terminal 100B transmitted completion information to the management server 200. A detailed description of completion information will be given later.

The vehicle information DB 204 is a database storing vehicle information related to the vehicles 30 standing by inside the vehicle base. The vehicle information DB 204 can be achieved by the auxiliary memory 230 in the management server 200. The vehicle information is information associating a vehicle ID that acts as an identifier for identifying each vehicle 30 with a boarding time, which is the time when one standby crew member 10A among the plurality of the standby crew members 10A boarded each vehicle 30. The boarding time is input on the basis of information such as a service schedule of the plurality of vehicles 30, for example.

The controller 201 generates schedule information including a crew order on the basis of the vehicle information and the crew information. Here, the crew order is an order of priority for when each of the plurality of standby crew members 10A boards one vehicle 30 among the plurality of vehicles 30. The controller 201 transmits the schedule information to the plurality of crew terminals 100A through the communication unit 202.

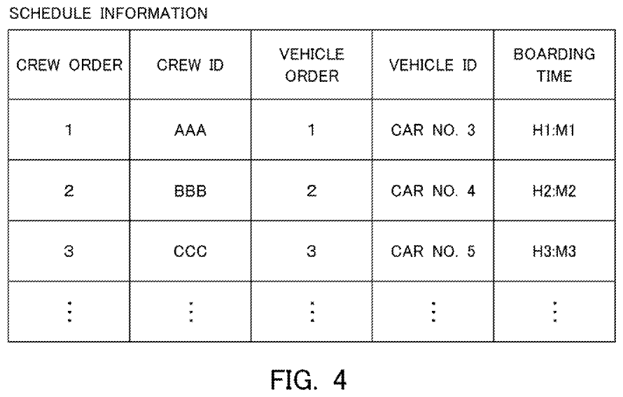

FIG. 4 is a diagram illustrating an example of a table structure of schedule information. As illustrated in FIG. 4, the schedule information includes a crew order field, a crew ID field, a vehicle order field, a vehicle ID field, and a boarding time field. The crew order is input into the crew order field. A crew ID corresponding to the crew order is input into the crew ID field. The controller 201 calculates the elapsed time from the exit time until the current time for each standby crew member 10A on the basis of the crew information. In other words, the calculated elapsed time is the time that has elapsed since the standby crew member 10A previously exited a vehicle 30. Then, the controller 201 determines the crew order in order of the longest calculated elapsed time. In other words, the controller 201 determines the crew order such that a standby crew member 10A having a longer elapsed time since previously exiting a vehicle 30 (the length of time spent on standby) is higher in the crew order.

A vehicle order, which is an order of priority for the vehicles 30 to be boarded by one standby crew member 10A among the plurality of standby crew members 10A, is input into the vehicle order field. A vehicle ID corresponding to the vehicle order is input into the vehicle ID field. The controller 201 determines the vehicle order of each vehicle 30 in order of earliest boarding time on the basis of the vehicle information. In other words, the controller 201 determines the vehicle order such that a vehicle 30 having an earlier boarding time is higher in the vehicle order. The boarding time for each vehicle 30 is input into the boarding time field.

(Crew Terminal Associated with Standby Crew Member)

The crew terminal 100A includes a controller 101A, a communication unit 102A, a display 103A, and an input unit 104A. The controller 101A has a function of performing computational processing for controlling the crew terminal 100A. The controller 101A can be achieved by a processor in the crew terminal 100A. The communication unit 102A has a function of connecting the crew terminal 100A to the network N1. The communication unit 102A can be achieved by a communication I/F in the crew terminal 100A. The display 103A has a function of displaying various information to the standby crew member 10A. The display 103A can be achieved by a touch panel in the crew terminal 100A. The input unit 104A has a function of inputting various information into the crew terminal 100A. The input unit 104A can be achieved by a touch panel in the crew terminal 100A.

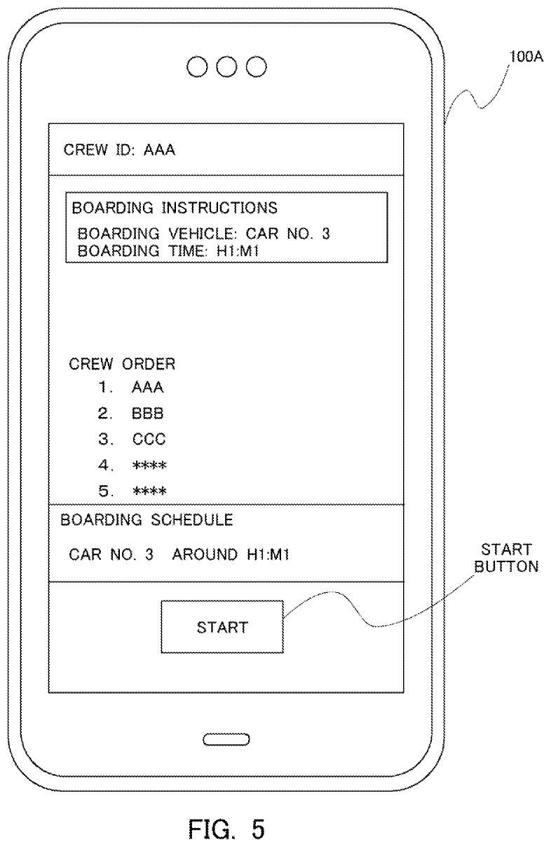

The controller 101A receives schedule information from the management server 200 through the communication unit 102A. The controller 101A receives the schedule information and causes a boarding screen related to the schedule information to be displayed on the display 103A. FIG. 5 is a diagram illustrating an example of a boarding screen in the present embodiment. FIG. 5 illustrates a boarding screen displayed on the crew terminal 100A associated with the standby crew member 10A having the crew ID “AAA”. Thus, “AAA” is displayed as the crew ID, as illustrated in FIG. 5. In the example of FIG. 5, a boarding screen displayed in the case where the crew terminal 100A receives the schedule information illustrated in FIG. 4 is illustrated. Also, as illustrated in FIG. 5, a boarding instruction, the crew order, and a boarding schedule are displayed on the boarding screen on the basis of the schedule information.

In the boarding instruction, the vehicle ID of the vehicle 30 in first place of the vehicle order in the schedule information is displayed as the boarding vehicle. Also, in the boarding instruction, the boarding time of the vehicle 30 in first place of the vehicle order in the schedule information is displayed. Note that the same content is displayed in the boarding instruction on all crew terminals 100A. In other words, the vehicle ID (Car No. 3) and the boarding time (H1:M1) of the vehicle 30 in first place of the vehicle order in the schedule information are displayed on all crew terminals 100A. With this arrangement, each standby crew member 10A is able to grasp the vehicle 30 in first place of the vehicle order (the vehicle 30 having the earliest boarding time) and the boarding time of the vehicle 30.

In the crew order, the crew order and the crew IDs of the plurality of standby crew members 10A in the schedule information are displayed in association with each other. With this arrangement, a standby crew member 10A who is high in the crew order is able to grasp that the elapsed time since previously exiting a vehicle 30 is longer than a standby crew member 10A who is low in the crew order. In other words, a standby crew member 10A who is high in the crew order is able to grasp that he or she has been standing by for a longer time than a standby crew member 10A who is low in the crew order. Consequently, the standby crew member 10A who is high in the crew order is encouraged to board the vehicle 30 in first place of the vehicle order (the boarding vehicle) and perform predetermined work. Note that the same content is displayed in the crew order on all crew terminals 100A.

On the boarding screen, a start button is displayed. When a standby crew member 10A has boarded the vehicle 30 displayed on the boarding screen (the boarding vehicle), he or she presses the start button on the boarding screen. Note that a standby crew member 10A is able to board the boarding vehicle even in the case where he or she is not in first place of the crew order. In this case, the standby crew member 10A not in first place of the crew order presses the start button when boarding the boarding vehicle. With this arrangement, even if the standby crew member 10A in first place of the crew order is unable to board the boarding vehicle, a standby crew member 10A in second or lower place of the crew order is able to board the boarding vehicle instead of the standby crew member 10A in first place of the vehicle order. As a result, it is possible to avoid a situation in which the boarding vehicle cannot travel the predetermined outside region because the standby crew member 10A in first place of the crew order is unable to board the boarding vehicle.

In the boarding schedule, information about the vehicle 30 in the same place of the vehicle order as the crew order of the standby crew member 10A associated with the crew terminal 100A is displayed on the basis of the schedule information. Specifically, the vehicle ID and the boarding time of the vehicle 30 in the same place of the vehicle order as the crew order of the standby crew member 10A associated with the crew terminal 100A are displayed in the boarding schedule. In the example illustrated in FIG. 5, the standby crew member 10A associated with the crew terminal 100A (the standby crew member 10A with the crew ID “AAA”) is in first place of the crew order, and therefore the vehicle ID and the boarding time for the vehicle 30 in first place of the vehicle order (Car No. 3) are displayed. As another example, on the crew terminal 100A associated with the standby crew member 10A with the crew ID “BBB” (the standby crew member 10A in second place of the crew order), the vehicle ID and the boarding time for the vehicle 30 in second place in the vehicle order (Car No. 4) are displayed. With this arrangement, a standby crew member 10A is able to grasp the vehicle 30 that he or she is to board and the boarding time for the vehicle 30 in the case where all of the standby crew members 10A higher in the crew order than himself or herself board the vehicles 30 in the order of the crew order.

When a standby crew member 10A presses the start button on the boarding screen, the controller 101A transmits boarding information indicating that the standby crew member 10A has boarded the boarding vehicle. The boarding information is information including the vehicle ID of the vehicle 30 treated as the boarding vehicle and the crew ID of the standby crew member 10A who has boarded the boarding vehicle. The management server 200 receives the boarding information and thereby can grasp that a standby crew member 10A has boarded the boarding vehicle and also ascertain the vehicle ID of the vehicle 30 that the standby crew member 10A has actually boarded.

(Crew Terminal Associated with Specific Crew Member)

A completion screen is displayed on the crew terminal 100B. On the completion screen, an arrival button that the specific crew member 10B presses when exiting a vehicle 30 after the vehicle 30 departs the vehicle base and arrives back at the vehicle base is displayed. When the specific crew member 10B presses the arrival button on the completion screen, completion information is transmitted to the management server 200. Here, the completion information is information indicating that the specific crew member 10B has exited the vehicle 30 he or she had been on board. The management server 200 receives the completion information and thereby can grasp that the specific crew member 10B has exited the vehicle 30 and also grasp that the vehicle 30 has arrived at the vehicle base. The completion information includes the crew ID for the specific crew member 10B and the vehicle ID for the vehicle 30 that the specific crew member 10B had been on board.

(Information/Process Flow)

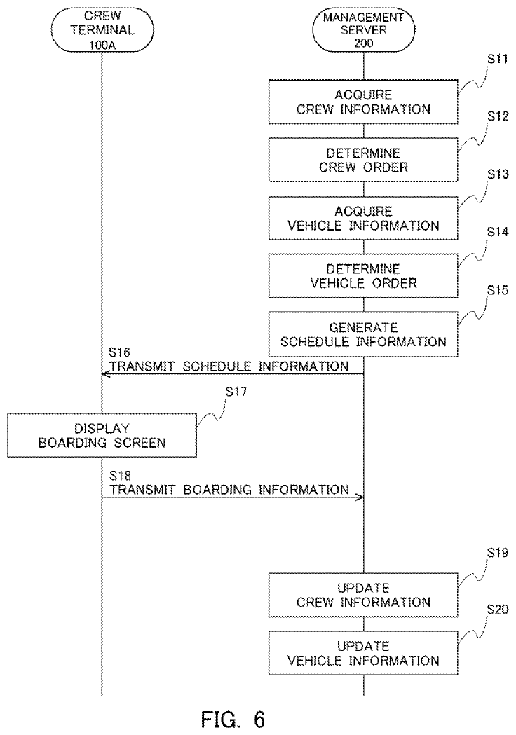

Next, a first flow of information and each process between the crew terminal 100A and the management server 200 in the work management system 1 will be described on the basis of FIG. 6. FIG. 6 is a sequence diagram illustrating a first flow of information and processing in the work management system 1. Note that transmission and reception of information as well as each process illustrated in FIG. 6 are executed repeatedly.

In the work management system 1, the management server 200 acquires crew information from the crew information DB 203 (S11). Next, the management server 200 determines the crew order on the basis of the acquired crew information (S12). The management server 200 acquires vehicle information from the vehicle information DB 204 (S13). Next, the management server 200 determines the vehicle order on the basis of the acquired vehicle information (S14). Then, the management server 200 generates schedule information including the crew order and the vehicle order (S15). The management server 200 transmits the generated schedule information to the plurality of crew terminals 100A (S16).

The crew terminal 100A receives the schedule information and displays the boarding screen (S17). The standby crew member 10A presses the start button on the boarding screen when boarding the boarding vehicle. In response, the crew terminal 100A transmits boarding information to the management server 200 (S18).

The management server 200 receives the boarding information and thereby can grasp that the standby crew member 10A associated with the crew terminal 100A that transmitted the boarding information has boarded the boarding vehicle (that is, the standby crew member 10A has become the specific crew member 10B). Accordingly, the management server 200 updates the crew information (S19). In other words, the management server 200 removes the information about the standby crew member 10A corresponding to the crew ID included in the boarding information from the crew information in the crew information DB 203. In addition, by receiving the boarding information, the management server 200 can grasp that the specific crew member 10B has boarded the vehicle 30 treated as the boarding vehicle. Accordingly, the management server 200 updates the vehicle information (S20). In other words, the management server 200 removes the information about the vehicle 30 corresponding to the vehicle ID included in the boarding information from the vehicle information in the vehicle information DB 204.

After that, the management server 200 executes the process of S11 again. At this time, the management server 200 acquires the crew information updated in S19 and the vehicle information updated in S20 when the flow has been executed previously. Thereafter, the management server 200 executes the processes from S12 to S16 again. The management server 200 transmits schedule information to a plurality of crew terminals 100A again. The plurality of crew terminals 100A at this time are the terminals associated with the plurality of standby crew members 10A at the time when the flow is executed currently.

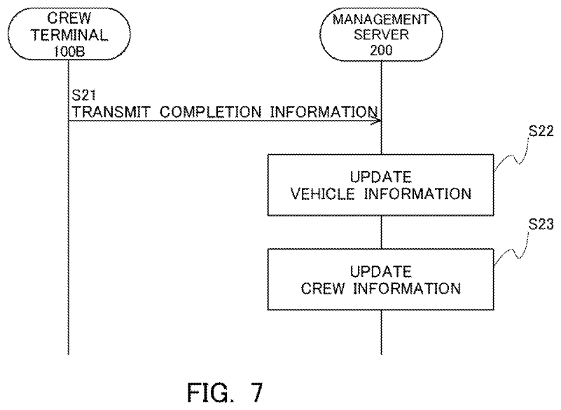

Next, a second flow of information and each process between the crew terminal 100B and the management server 200 in the work management system 1 will be described on the basis of FIG. 7. FIG. 7 is a sequence diagram illustrating a second flow of information and processing in the work management system 1.

In the work management system 1, when a vehicle 30 arrives at the vehicle base and the specific crew member 10B exits the vehicle 30, the specific crew member 10B presses the arrival button on the completion screen displayed on the crew terminal 100B. When the specific crew member 10B presses the arrival button on the completion screen, the crew terminal 100B transmits completion information to the management server 200 (S21).

The management server 200 receives the completion information and updates the vehicle information (S22). In other words, the management server 200 acquires the vehicle ID included in the completion information and adds the vehicle ID to the vehicle information stored in the crew information DB 203. Additionally, for example, the management server 200 adds the boarding time for the vehicle 30 corresponding to the vehicle ID included in the completion information to the vehicle information stored in the crew information DB 203 on the basis of information such as a service schedule. In this way, by having the management server 200 update the vehicle information on the basis of the completion information, information about the vehicle 30 that has arrived at the vehicle base is added to the vehicle information in the vehicle information DB 204.

The management server 200 receives the completion information and updates the crew information (S23). In other words, the management server 200 acquires the crew ID included in the completion information and adds the crew ID to the crew ID field in the crew information stored in the crew information DB 203. The management server 200 also inputs the time at which the crew terminal 100B associated with the specific crew member 10B transmitted the completion information into the exit time field in the crew information as the exit time for the specific crew member 10B. In this way, by having the management server 200 update the crew information on the basis of the completion information, information about a specific crew member 10B who has exited a vehicle 30 is added to the crew information in the crew information DB 203 as information about a standby crew member 10A.

As described above, through the work management system 1, the plurality of standby crew members 10A are encouraged to board the vehicle 30 in first place of the vehicle order (the boarding vehicle) and perform predetermined work in the order of the standby crew member 10A with the longest elapsed time since previously exiting a vehicle 30. With this arrangement, the work by the plurality of crew members 10 can be managed by the work management system 1.

(Modifications)

In the present embodiment, the crew terminal 100A and the crew terminal 100B are a single terminal. However, the crew terminal 100A and the crew terminal 100B may also be different terminals. In this case, when the standby crew member 10A boards a vehicle 30 (the boarding vehicle), the standby crew member 10A presses the start button on the boarding screen on the crew terminal 100A. In response, the crew terminal 100A transmits boarding information to the management server 200. Also, when the specific crew member 10B exits a vehicle 30, the specific crew member 10B presses the arrival button on the completion screen on the crew terminal 100B. In response, the crew terminal 100B transmits completion information to the management server 200.

In the present embodiment, only a boarding instruction for the vehicle 30 in first place of the vehicle order is displayed on the boarding screen. However, boarding instructions for a plurality of vehicles 30 down to a predetermined place in the vehicle order and including the vehicle 30 in first place of the vehicle order may also be displayed on the boarding screen. In this case, the standby crew member 10A selects the vehicle 30 that he or she is to board from among the plurality of boarding instructions. When the standby crew member 10A presses the start button on the boarding screen, boarding information including the crew ID for the standby crew member 10A and the vehicle ID for the vehicle 30 selected by the standby crew member 10A is transmitted to the management server 200. Also in this case, the crew information and the vehicle information likewise are updated on the basis of the received boarding information.

### Second Embodiment

In the present embodiment, it may be necessary to replace a specific crew member 10B with a standby crew member 10A from among the plurality of standby crew members 10A. In this case, the management server 200 transmits replacement instruction information to the plurality of crew terminals 100A. The replacement instruction information is information giving an instruction for replacing a specific crew member 10B with a standby crew member 10A from among the plurality of standby crew members 10A. Hereinafter, only the points that differ from the first embodiment will be described.

(Functional Configuration)

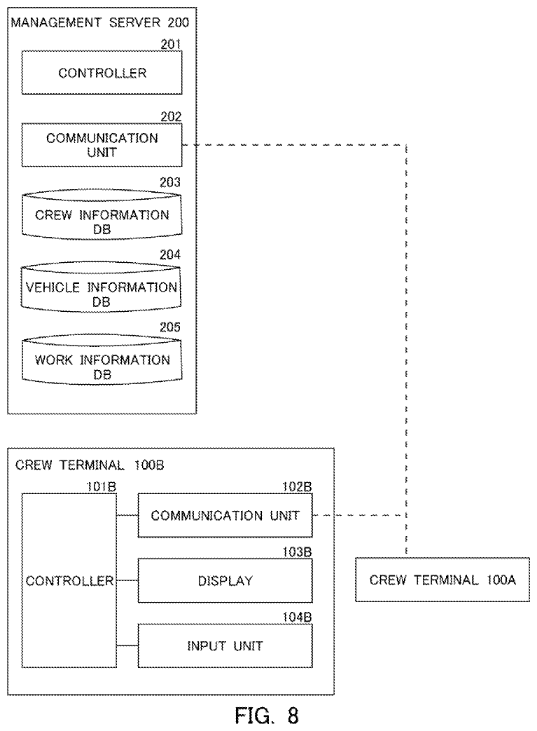

The work management system 1 according to the present embodiment will be described for a functional configuration of each of the crew terminal 100A, the crew terminal 100B, and the management server 200 on the basis of FIGS. 8 to 10. FIG. 8 is a block diagram schematically illustrating an example of a functional configuration of the crew terminal 100A, the crew terminal 100B, and the management server 200 in the present embodiment.

(Management server)

As illustrated in FIG. 8, the management server 200 additionally includes a work information database (work information DB) 205. The work information DB 205 can be achieved by the auxiliary memory 230 in the management server 200. The controller 201 generates work information. The work information is information related to work by each of the plurality of specific crew members 10B. The controller 201 stores the generated work information in the work information DB 205.

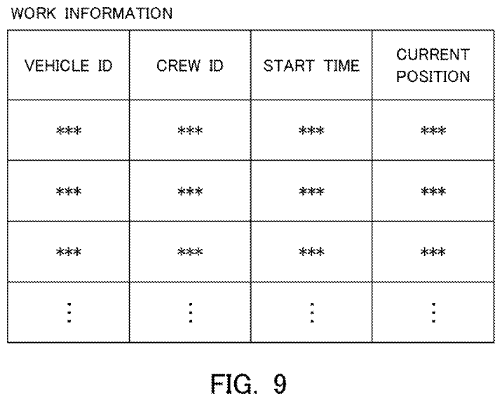

FIG. 9 is a diagram illustrating an example of a table structure of work information. As illustrated in FIG. 9, the work information includes a crew ID field, a vehicle ID field, a start time field, and a current position field. In the vehicle ID field and the crew ID field, the vehicle ID of the vehicle 30 that the specific crew member 10B is on board (hereinafter referred to as the “specific vehicle” in some cases) and the crew ID of the specific crew member 10B are input, respectively. In the start time field, the time at which the crew terminal 100A associated with the standby crew member 10A transmitted the boarding information is input. In other words, the time at which the standby crew member 10A became the specific crew member 10B is input into the start time field. The controller 201 acquires the current position of the specific vehicle 30 from the specific vehicle 30, from the crew terminal 100B associated with the specific crew member 10B, or from a server apparatus that manages the current position of the specific vehicle 30. The acquired current position of the specific vehicle 30 is input into the current position field.

In the case where a predetermined condition for replacing the specific crew member 10B on board the specific vehicle with a standby crew member 10A from among the plurality of standby crew members 10A is established, the management server 200 transmits replacement instruction information to the plurality of crew terminals 100A. Here, the replacement instruction information is information giving an instruction to replace the crew member on board the specific vehicle 30. The replacement instruction information includes the vehicle ID of the specific vehicle 30 and the current position of the specific vehicle 30.

One of the predetermined condition is that the length of time that the specific crew member 10B has been on board the specific vehicle 30 (hereinafter referred to as the “work time” in some cases) is a predetermined threshold or longer. The controller 201 calculates the work time of each specific crew member 10B on the basis of the work information. Then, the controller 201 determines whether or not the calculated work time of each specific crew member 10B is the predetermined threshold or longer. In the case where a specific crew member 10B having a work time equal to the predetermined threshold or longer exists, the controller 201 transmits replacement instruction information regarding the specific crew member 10B to the plurality of crew terminals 100A. Accordingly, a standby crew member 10A is able to replace the specific crew member 10B having a work time that is equal to the predetermined threshold or longer. As a result, a situation in which the specific crew member 10B stays on board the specific vehicle 30 for a long time can be avoided.

Alternatively, one of the predetermined condition is that the management server 200 receives request information from the crew terminal 100B. Here, the request information is information indicating that the specific crew member 10B is requesting replacement by a standby crew member 10A from among the plurality of standby crew members 10A. With this arrangement, the management server 200 can grasp that the specific crew member 10B needs to be replaced by a standby crew member 10A. Accordingly, when the request information is received, the controller 201 transmits to the plurality of crew terminals 100A replacement instruction information regarding the specific crew member 10B associated with the crew terminal 100B that transmitted the request information.

(Crew Terminal Associated with Specific Crew Member)

The controller 101B in the crew terminal 100B transmits the request information to the management server 200 through the communication unit 102B. The request information includes the crew ID for the specific crew member 10B and the vehicle ID for the vehicle 30 that the specific crew member 10B is on board.

(Crew Terminal Associated with Standby Crew Member)

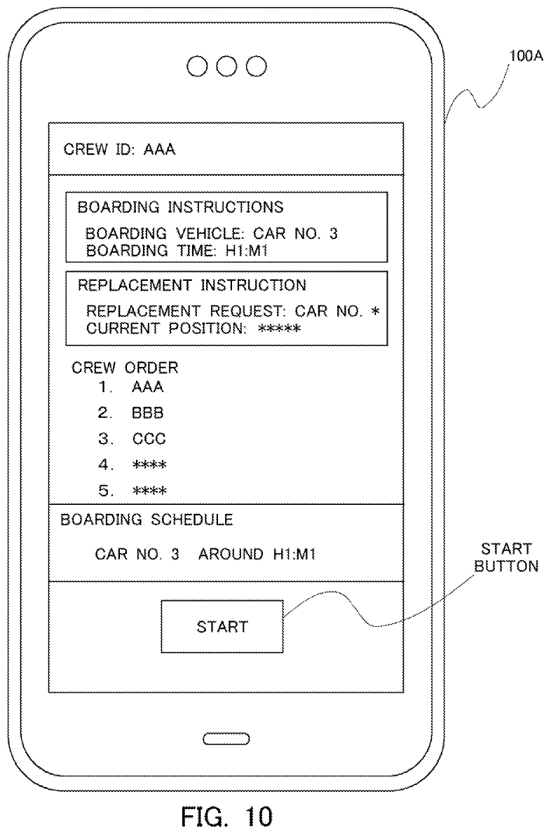

The controller 101A in the crew terminal 100A receives the replacement instruction information from the management server 200 through the communication unit 102A. At this time, the controller 101A causes a replacement instruction to be displayed on the boarding screen on the basis of the replacement instruction information. FIG. 10 is a diagram illustrating an example of a boarding screen in the present embodiment. As illustrated in FIG. 10, a replacement instruction is displayed on the boarding screen. In the replacement instruction, the vehicle ID and the current position included in the replacement instruction information are displayed. In the case of replacing the specific crew member 10B who needs to be replaced, the standby crew member 10A selects the replacement instruction and presses the start button. At this time, the controller 101A transmits replacement information to the management server 200 through the communication unit 102A. The replacement information includes the crew ID for the standby crew member 10A associated with the crew terminal 100A that transmitted the replacement information. The standby crew member 10A who pressed the start button moves to the current position of the vehicle 30 included in the replacement instruction information, and replaces the specific crew member 10B.

The management server 200 receives the replacement information and transmits replacement start information indicating that replacement information has been received to the plurality of crew terminals 100A. Each crew terminal 100A receives the replacement start information and removes the replacement instruction displayed on the boarding screen. Also, when the replacement information is received, the management server 200 removes the information about the standby crew member 10A associated with the crew terminal 100A that transmitted the replacement information from the crew information stored in the crew information DB 203.

(Replacement Instruction Process)

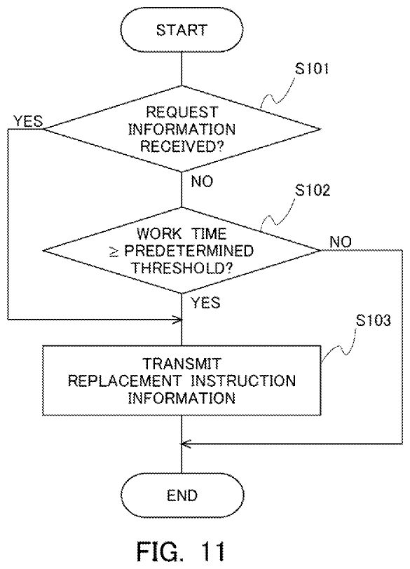

A replacement instruction process executed by the controller 201 of the management server 200 in the work management system 1 according to the present embodiment will be described on the basis of FIG. 11. FIG. 11 is a flowchart of the replacement instruction process. The replacement instruction process is a process for transmitting replacement instruction information to the plurality of crew terminals 100A. The replacement instruction process is executed periodically at predetermined intervals.

In the replacement instruction process, first, in S101, a determination of whether or not request information has been received is made. In the case of a positive determination in S101, the controller 201 determines that the specific crew member 10B needs to be replaced by a standby crew member 10A from among the plurality of standby crew members 10A. Accordingly, in S103, replacement instruction information regarding the specific crew member 10B associated with the crew terminal 100B that transmitted the request information is transmitted to the plurality of crew terminals 100A. In the case of a negative determination in S101, in S102, a determination of whether or not a specific crew member 10B having a work time equal to a predetermined threshold or longer exists among the specific crew members 10B is made. In the case of a positive determination in S102, the controller 201 determines that the specific crew member 10B needs to be replaced by a standby crew member 10A from among the plurality of standby crew members 10A. Accordingly, in S103, replacement instruction information regarding the specific crew member 10B having a work time equal to the predetermined threshold or longer is transmitted. In the case of a negative determination in S102, the replacement instruction process ends.

As described above, with the work management system 1 according to the present embodiment, a specific crew member 10B can be replaced by a standby crew member 10A. With this arrangement, the plurality of crew members 10 are able to board the vehicles 30 flexibly to perform predetermined work. In this way, the work by the plurality of crew members 10 can be managed by the work management system 1.

### Other Embodiments

The embodiments described above are merely examples, and the present disclosure may be carried out by making appropriate modifications within a scope that does not depart from the gist of the present disclosure. Additionally, the processes and means described in the present disclosure may be combined freely, insofar as a technical contradiction is not produced.

Also, a process described as being performed by a single apparatus may also be executed in a distributed manner by a plurality of apparatuses. Alternatively, a process described as being performed by different apparatuses may be executed by a single apparatus. In a computer system, the kind of hardware configuration (server configuration) with which each function is achieved can be modified flexibly.

The present disclosure is also achievable by supplying a computer program implementing the functions described in the foregoing embodiments to a computer, and causing one or more processors included in the computer to load and execute the program. Such a computer program may be provided to the computer through a non-transitory computer readable medium that is connectible to a system bus of the computer, or may be provided to the computer over a network. The non-transitory computer readable medium includes any type of medium suited to storing electronic instructions, including any type of disk such as a magnetic disk (such as a floppy(R) disk or a hard disk drive (HDD)) or an optical disc (such as a CD-ROM, a DVD, or a Blu-ray Disc), read-only memory (ROM), random access memory (RAM), EPROM, EEPROM, a magnetic card, flash memory, or an optical card, for example.

What is claimed is:

1. An information processing apparatus that manages work by a plurality of crew members who perform predetermined work on board a vehicle among a plurality of vehicles, the information processing apparatus comprising a controller comprising at least one processor configured to:
determine a crew order that is an order of priority for each of the plurality of crew members to board a vehicle among the plurality of vehicles, the crew order being determined in order of a longest elapsed time since each of the plurality of crew members previously exited a vehicle among the plurality of vehicles; and
transmit schedule information including the crew order to a plurality of first terminals respectively associated with the plurality of crew members.

2. The information processing apparatus according to claim 1, wherein the controller is further configured to transmit replacement instruction information giving an instruction to replace a specific crew member to the plurality of first terminals in a case where a predetermined condition is established for replacing the specific crew member on board a vehicle among the plurality of vehicles with a crew member among the plurality of crew members.

3. The information processing apparatus according to claim 2, wherein the predetermined condition is that a length of time that the specific crew member has been on board the vehicle among the plurality of vehicles is a predetermined threshold or longer.

4. The information processing apparatus according to claim 2, wherein the predetermined condition is that the controller receives request information indicating that the specific crew member requests to be replaced by a crew member among the plurality of crew members from a second terminal associated with the specific crew member.

5. The information processing apparatus according to claim 1, wherein the schedule information additionally includes a vehicle order related to the plurality of vehicles that is an order of priority for being boarded by a crew member among the plurality of crew members.

6. The information processing apparatus according to claim 1, wherein the controller is configured to update and retransmit the schedule information to the plurality of first terminals in a case where the controller receives, from a first terminal among the plurality of first terminals, boarding information indicating that an associated crew member has boarded a vehicle.

7. The information processing apparatus according to claim 4, wherein the first terminal and the second terminal are a single terminal.

8. An information processing method executed by a computer that manages work by a plurality of crew members who perform predetermined work on board a vehicle among a plurality of vehicles, the information processing method comprising:
determining a crew order that is an order of priority for each of the plurality of crew members to board a vehicle among the plurality of vehicles, the crew order being determined in order of a longest elapsed time since each of the plurality of crew members previously exited a vehicle among the plurality of vehicles; and
transmitting schedule information including the crew order to a plurality of first terminals respectively associated with the plurality of crew members.

9. The information processing method according to claim 8, further comprising
transmitting replacement instruction information giving an instruction to replace a specific crew member to the plurality of first terminals in a case where a predetermined condition is established for replacing the specific crew member on board a vehicle among the plurality of vehicles with a crew member among the plurality of crew members.

10. The information processing method according to claim 9, wherein the predetermined condition is that a length of time that the specific crew member has been on board the vehicle among the plurality of vehicles is a predetermined threshold or longer.

11. The information processing method according to claim 9, wherein the predetermined condition is that the computer receives request information indicating that the specific crew member requests to be replaced by a crew member among the plurality of crew members from a second terminal associated with the specific crew member.

12. The information processing method according to claim 8, wherein the schedule information additionally includes a vehicle order related to the plurality of vehicles that is an order of priority for being boarded by a crew member among the plurality of crew members.

13. The information processing method according to claim 8, wherein the schedule information is updated and retransmitted to the plurality of first terminals in a case where boarding information is received from a first terminal among the plurality of first terminals, indicating that an associated crew member has boarded a vehicle.

14. A non-transitory storage medium storing a program executed by a computer that controls a terminal associated with each of a plurality of crew members who perform predetermined work on board a vehicle among a plurality of vehicles, the program causing the terminal to:
receive, from an information processing apparatus that manages the work by the plurality of crew members, schedule information including a crew order that is an order of priority for each of the plurality of crew members to board a vehicle among the plurality of vehicles and a vehicle order related to the plurality of vehicles that is an order of priority for being boarded by a crew member among the plurality of crew members; and
display the crew order for the plurality of crew members and a vehicle that is in first place of the vehicle order among the plurality of vehicles on a display.

15. The non-transitory storage medium according to claim 14, wherein the program causes the terminal to display a plurality of vehicles down to a predetermined place in the vehicle order including the vehicle in first place of the vehicle order on the display.

16. The non-transitory storage medium according to claim 14, wherein the program causes the terminal to display information about a vehicle in the same place of the vehicle order as the crew order of a crew member associated with the terminal on the display on a basis of the schedule information.

17. The non-transitory storage medium according to claim 14, wherein the program causes the terminal to transmit, to the information processing apparatus, boarding information indicating that a crew member associated with the terminal has boarded the vehicle displayed on the display.

18. The non-transitory storage medium according to claim 14, wherein the program causes the terminal to
receive, from the information processing apparatus, replacement instruction information giving an instruction to replace a specific crew member on board a vehicle among the plurality of vehicles with a crew member among the plurality of crew members, and
display the replacement instruction information on the display.

19. The non-transitory storage medium according to claim 18, wherein
the replacement instruction information includes a current position of the vehicle that the specific crew member is on board, and
the vehicle that the specific crew member is on board and the current position are displayed on the display.

20. The non-transitory storage medium according to claim 18, wherein the program causes the terminal to transmit replacement information indicating replacement to the information processing apparatus in a case where a crew member associated with the terminal replaces the specific crew member.
